(19) United States
(12) Patent Application Publication
(10) Pub. No.: US 2009/0300142 A1
(43) Pub. Date: Dec. 3, 2009

(54) METHOD AND SERVICE IN A PUBLIC NETWORK FOR DOING MUTUAL BUSINESS

(76) Inventor: Mauri Ahlberg, Helsinki (FI)

Correspondence Address: FASTH LAW OFFICES (ROLF FASTH), 26 PINECREST PLAZA, SUITE 2, SOUTHERN PINES, NC, 28387-4301, US

(21) Appl. No.: 12/128,071

(22) Filed: May 28, 2008

(51) Int. Cl. G06F 15/16

(52) U.S. Cl. 709/218

(57) ABSTRACT

The method takes place in a public telecommunication network. It is question about mutual business between a client and a service provider, which provide services for each other. The service provider has a service that consists of information to be presented for users on computers connected to the network. In the method, the client sends content to be used in the service provided by the service provider. The service provider publishes the content sent in the service together with contact information of the client. The invention is also concerned with such a service in a public telecommunication network to be presented for users on computers connected to the network.

### FIELD OF THE INVENTION

The invention is concerned with a method and service in a public telecommunication network for doing mutual business between a client and a service provider by providing services for each other, the service provided by the service provider consisting of information to be presented for users on computers connected to the network.

### BACKGROUND OF THE INVENTION

In the old days, all scientific and other information for encyclopedias was presented in books and when the information or a part of it became antiquated or out-of-date, new books had to be printed of collected new information.

Nowadays, a lot of information databases and encyclopedias exist on-line and are presented for users at computers. Also web sites offer many different types of databases and information resources.

An example is Wikipedia, which is a free, open content, community-built encyclopedia with thousands of articles on topics from A to Z available in dozens of languages. It is an encyclopedia that anyone can edit critics and argue, why it also is vulnerable to endless mistakes.

Even if composed of editors acting independently and for their own reasons, the result is a very useful resource. The editors receive both psychological satisfaction and material usefulness from their contributions, the project has grown to include safeguards that help guarantee that the development of the project will move in a positive direction—towards broad, accurate articles that depend on reliable, verifiable sources.

Like Wikipedia, the databases and information services on internet are often categorized by subject and besides the mere information presentation purpose, other services may be involved.

WO publication 2006/120286 of the applicant presents a service for identification of objects, especially for identification of objects in the nature, such as plants, animals and minerals. It is meant for people walking in the nature who want to identify different objects and phenomena in nature, such as plants, mushrooms, stones, minerals, butterflies, insects, animals and phenomena in the sky. The service comprises a database with objects classified on the basis of their position and their characteristic(s).

The service fetches information on the basis of the position of the object and the selected characteristic(s) from a database. The fetched information is presented for the user device in the form of alternative objects to be identified as one or more photographs, images, drawings, symbols and/or texts.

The invention is primarily meant for identification of objects in the nature, such as plants, mushrooms, stones, minerals, butterflies, insects, animals and phenomena in the sky. It can, however, be extended to other suitable things, e.g. to identification of stars, planets, or different types of clouds, auroras etc, weather forecasts, other future forecasts, such as possible development of the local nature in question, and also for localization of sights, cities, villages etc.

Because of the success of e.g. Wikipedia, the applicants believe that an information service in which different people can participate with information is successful and also solves the problem with updating information continuously.

The object of this invention is therefore to provide an information service on-line to which anyone can give contribution but by having an improved and faster development of the information content and by simultaneously avoiding the problem with including wrong information and mistakes.

Another object of the invention is to provide a commercially interesting solution for the realization of the first object.

### SUMMARY OF THE INVENTION

The method of the invention takes place in a public telecommunication network. It is question about mutual business between a client and a service provider. The service provider has a service that consists of information to be presented for users on computers connected to the network. In the method, the client sends content to be used in the service provided by the service provider. The service provider publishes the content sent for the service together with contact information of the client.

The invention is also concerned with such a service in a public telecommunication network to be presented for users on computers connected to the network. The service consists of pieces of content information together with contact information of the author of each piece of information.

The public telecommunication network is primarily meant to be the Internet.

Thus, preferably, the client accepts the conditions of the service provider for publishing before the service provider publishes the content and the service provider in turn studies and accepts the content and fits it into the service before publishing the content.

Primarily, the invention is intended to be used for content consisting of systematically presented scientific information for the public e.g. in the form of photographs, images, drawings, symbols and/or texts.

The contact information of the client to be published together with the content sent by the client can consist of author information, time and place information, and technical information of the photograph. Additional information can be published together with the content such as scientific links to relevant information and also relevant commercial links regarding buying and selling of the photograph.

The access to contact and additional information, sent by the client and presented in connection with the content presentation, is performed by clicking with the mouse on places that are activated after which e.g. a window with information is opened on the screen or a new page.

The invention provides many advantages not found by any other existing internet service. Like some previously known services, it enables anyone to participate in the content, but as an advantageous part of the invention and in contradiction to these earlier services, the service provider checks all information to be included in the service and thereby the quality and accuracy of the service is guaranteed. In addition, it can works as a portal for people with common interests and people who want to do business with each other.

Furthermore, a direct business win-win relation between the service provider and the client is established. The service provider get content to the service and the client participating in the content making, has a market place for doing business with his contribution.

One application of the invention is to use it in connection with a particular service, which is presented by the applicants in WO publication 2006/120286, and is a service for identification of objects, especially for identification of objects in the nature, such as plants, animals and minerals. This service has been commercialized with the trade mark NatureGate®. The invention is primarily meant to be used in this service but can of course be realized in other kind of services as well.

NatureGate® provides patented software for fast and easy identification of any object by its observable characteristics on the web. As a part of this service, excellent and at the same time scientifically accurate and beautiful nature photographs and videos, are presented. The service enables that e.g. photos and videos of flowering plants can be interactively and easily found based on colors, shape of flower, shape of leaves, height etc. The idea of the NatureGate® service is to use the best possible photos and videos, which are continually checked by experts. All experts and photographers use their own names. Clients can trust the correctness of information and knowledge provided by the NatureGate® service. In this way it is different to services on the web, which are not scientifically checked.

The best nature photographers will understand that when participating in the content of a service like this, especially in the NatureGate® service, there is a total win-win situation when they upload there photos to the server of this service and sign digitally an agreement that they e.g. retain all rights but give NatureGate® the right to use their photos permanently. In this way, they will become a part of the NatureGate® service. Their photos become accessible for users using this NatureGate® service, which is a patented fast and easy-way to-use software for finding information of objects based on observed characteristics. E.g. if a client wants to find yellow belly shaped flowers with round shaped leaves she can easily find such flowers in the service out of thousand of photos and videos. The client does not need to know any names, neither any common or scientific ones. She just ha to decide the object of interest.

The photos and videos in the service can be presented on the full the screen. There will be no copyright of the photographer directly seen on the photo, no advertisements, no text but still the contact information of the photographers will be easily accessed by means of the invention. The nature experience will be maximal and the advertising information will not be annoying for the visitors of the service, but they will easily access the information if so desired by clicking on places on the screen to be activated after which e.g. a window with contact and other information will appear. The best and fullest available produced by digital web media and user's computer equipments. This is again an example of the total win-win strategy™ by the applicant.

The user can e.g. use the right side of the button of the mouse to move back and forth. The characteristics attached to the photo itself, at least the name of photographer, the information whether she wants to sell her/his photo by herself/himself or through NatureGate® service, and the links, lead to purchasing digitally photos or any other products based on this/those photos.

In one application, a further click on the window, will link to products based or linked onto the organism or any other natural object in the photo in which the client is interested. It can e.g. be question about e.g. cosmetics made by oils of that plant. If he is interested on nature tourism and wants to experience the object himself or in photographing, he is connected to advertisements of those kinds of businesses, sites, regions, organizations etc. This is from producers' side user-community focused advertisement.

The invention provides a possibility to combine scientific information spreading and business in a new and discrete form.

Many users want more scientific knowledge of organism species or of ecosystems. Many users want more information about climate change, environmental problems, environmental education, and about sustainable development. Each species and ecosystem will be connected also to the best scientific discussion available about integrating ecologically, economically and socially sustainable development according to international agreements. They will have links to the best available scientific knowledge of the species and ecosystems involved. Biodiversity threats and free ecosystem services will be discussed in the service. This is one of the reasons why users will have a reason to primarily use the NatureGate® service, and also because it will have the best photos, and videos and the best, continually checked and improved scientific knowledge. This is again an example of the total win-win strategy™ since if this service is widely used it will also be commercially interesting for advertisers.

Next, the invention will be described by means of some examples and by referring to FIGURES, which are solely presented for illustrative purposes and not meant to restrict the invention in any way.

### BRIEF DESCRIPTION OF THE DRAWINGS

FIG. 1 presents a general flow scheme of one preferable embodiment of the invention

### DETAILED DESCRIPTION

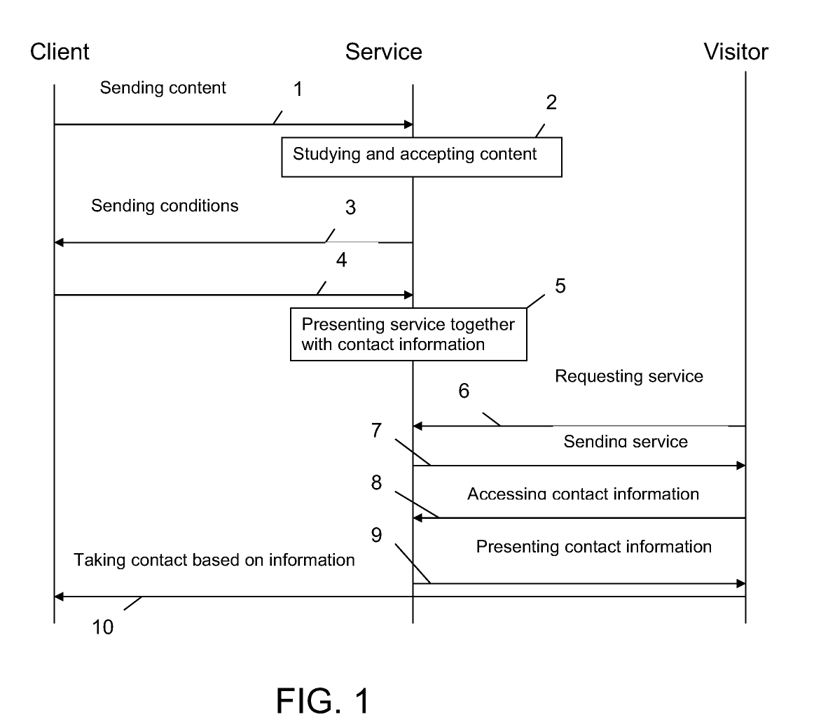

FIG. 1 presents a general flow scheme of one preferable embodiment of the invention. The method of FIG. 1 takes place in a public telecommunication network that can be the Internet. A service provider has an internet service in the network. Clients that want to do mutual business with the service provider are also connected to the network as well as users using the service (visitors of the service) of the service provider.

In the particular example of FIG. 1, such a service is presented for users on computers connected to the network, which service consists of systematically presented scientific information for the public preferably by means of web pages on the internet. By means of the service, objects in the nature, such as plants, animals and minerals, can be identified. The service is presented for the user device in the form of photographs, images, drawings, symbols and/or texts so that the user device connects to said service that has a database. In this database the objects to be identified are classified on the basis of different characteristics in a hierarchic system by means of a main menu of objects to be identified and submenus on different levels describing characteristics of the objects to be identified. When the user has selected what he wants to identify, characteristics of such an object are presented from the database on the basis of the position of the object found. The user selects one or more characteristics presented in the database of the service for an object to be identified and the service fetches information on the basis of the position of the object and the selected characteristic(s) from the database. The fetched information is presented for the user device in the form of one or more alternative objects to be identified. For more details about this service, reference is made to e.g. WO publication 2006/120286

With this service, the service provider strives to maximize accuracy and quality of photographs, images and videos presented. A further goal is to facilitate and speed up finding of better and better scientific and nature photographs to present for a growing user and visitor society and to enable advertisement income as a common benefit.

Therefore, the public is invited to participate in the content in terms of doing mutual business.

Clients are therefore given the possibility to present texts and photographs as a part of the service with connected contact information, so that visitors could take contact with them for business purposes. The access to contact and additional information is presented in connection with the content presentation on places in the service, such as in some corner of an internet web page presenting e.g. a photograph in the service, which can be activated by clicking with the mouse of the keyboard of the computer. In turn, the service provider gets content to their service.

An example of how such a business relation can be established is presented in the signal diagram of FIG. 1.

A client that has some content that he would like to be presented in the service is sent by signal 1 to the service provider.

In step 2, the service provider first studies the content (such as a photograph) and if the content is accepted by the service provider to be presented in the service, the service provider sends some business conditions (or a business contract) to the client in signal 3. In signal 4, the client accepts the business conditions (or sends a signed contract) to the service provider.

The service provider can now fit the content into the service and present the content of the client, together with contact information to the client in his service in step 5. The contact information is also provided by the client either in a separate signal or together with the acceptance of the conditions or with the content and can consist of e.g. the name of the client, the telephone number, the address, the e-mail address, a company name etc.

Another visitor now requests the service in signal 6 and gets it in signal 7. It is assumed that this visitor gets interested in doing business with a client that has sent content to the service after having seen something interesting.

The visitor can activate contact information from a web page of the internet service and access the contact information in signal 8. The contact information appears on the web page after signal 9.

After that, the visitor can take contact with the client in signal 10.

In further embodiments, other links could be activated from the same web page of the service such as, scientific links to e.g. information about sustainable development, business links to e.g. prizes for buying the content, or links for other purposes, such as nature traveling, gardens having the pieces in question, etc.

1. A method in a public telecommunication network for doing mutual business between a client and a service provider, comprising:
the service provider providing a service consisting of information to be presented for users on computers connected to the network,
the client sending content to be used in the service provided by the service provider, and the service provider publishing the content sent for the service together with contact information of the client.

2. The method of claim 1, wherein the client accepts the conditions of the service provider for publishing before the service provider publishes the content.

3. The method of claim 1, wherein the content to be presented in the service consists of systematically presented scientific information for the public.

4. The method of claim 1, wherein the service provider studies and accepts the content and fits the content into the service before publishing the content.

5. The method of claim 1, wherein the information in the service is presented for the user device in the form of photographs, images, drawings, symbols and/or texts.

6. The method of claim 1, wherein the content sent by the client to the service is in the form of photographs, images, drawings, symbols and/or texts.

7. The method of claim 1, wherein the content is a photograph and the contact information of the client to be published together with the content sent by the client consists of author information, time and place information, information, and technical information of the photograph.

8. The method of claim 1, wherein additional information is published together with the content sent by the client such as scientific links to relevant information.

9. The method of claim 1, wherein additional information is published together with the content sent by the client.

10. The method of claim 1, wherein the access to contact and additional information sent by the client is presented ion connection with the content presentation is performed by clicking with the mouse on places that are activated.

11. A service in a public telecommunication network to be presented for users on computers connected to the network, the service consisting of pieces of content information together with contact information of the author of each piece of information.

12. The service of claim 11, wherein the content to be presented in the service consists of systematically presented scientific information for the public.

13. The service of claim 11, wherein the service presents content for identification of objects in the nature.

14. The service of claim 11, wherein the information in the service is presented for the user device in the form of photographs, images, drawings, symbols and/or texts.

15. The service of claim 11, wherein the access to contact and additional information sent by the client is presented ion connection with the content presentation takes place by means of places to be activated by clicking with the mouse.

16. The service of claim 11, wherein the contact and additional information is presented on different parts of the content.

17. The service of claim 11, wherein the public telecommunication network is internet.
